(19) United States
(12) Patent Application Publication
(10) Pub. No.: US 2004/0163299 A1
(43) Pub. Date: Aug. 26, 2004

(54) Method and apparatus for producing pet memorabilia

(76) Inventor: Laura D. Werb, Fountain Hills, AZ (US)

Correspondence Address: TOD R. NISSLE, P.C., P.O. Box 55630, Phoenix, AR, 85078, US

(21) Appl. No.: 10/373,392

(22) Filed: Feb. 24, 2003

(51) Int. Cl. A47G 1/06

(52) U.S. Cl. 40/800; 206/575

(57) ABSTRACT

A method and apparatus for preparing pet memorabilia utilizes both the efforts of a pet owner and of a processing center remote from the residence of the pet owner. The method employs materials provided in a container. The materials enable a pet owner to take an impression of the paw of a dog or other pet. The container is sized to receive the impression. The container is designed to be mailed to the remote processing center. The remote processing center using the impression to prepare a casting. A special cellulose—silicate casting material is used to take a casting. After the casting is completed, it is mounted on a display and returned to the pet owner.

This invention pertains to memorabilia.

More particularly, the invention pertains to pet memorabilia that is prepared in part by a pet owner and in part by another party at a location remote from the residence of the pet owner.

In another respect, the invention pertains to a method and apparatus that facilitates the ready production of a casting of the paw of a pet.

Plaster, clay, gels, metals, and other materials have long been used to produce “negative” impressions of various objects for a variety of reasons. For example, some manufacturing processes require the production of impressions from which castings or moldings are produced. Molds used to make a wide variety of plastic products are one example of a “negative impression” that is used to produce in volume moldings of a particular product. Another example of common negative impressions are impressions made in clay or other soft malleable materials. Children press their hands in putty or clay to make a negative impression of their hands. Pet owners press a paw of their pet in soft plaster or in clay to make a negative impression of the pet's paw.

However, castings of a pet's paw apparently are not readily available to the pet owner.

One reason castings may not be available is that many casting materials, for example liquid acrylic resins, are toxic.

Another reason castings may not be available is that many casting materials are, when dry, brittle and breakable.

A further reason castings may not be available is that the materials used to make a casting shrink appreciably when dried, or, if the material does not shrink it is unduly expensive or difficult to use. Metals like silver and copper may not shrink unduly on cooling but must be heated to unusually high temperatures and can be expensive.

Still another reason castings may not be available to pet owners is that the casting material does not pick up fine details found in the mold or “negative impression” in which the casting material is used.

Still a further reason castings may not be available is that when the casting material hardens it is not readily sculpted, but instead requires significant effort to be trimmed, smoothed, and contoured.

Yet another reason castings may not be available is that the casting material sticks to the mold.

Yet a further reason castings may not be available is that the casting material dries so rapidly it is difficult to sculpt.

Yet still a further reason castings may not be available to a pet owner is that the process of producing a casting can require time and skills not readily available to a pet owner.

Accordingly, it would be highly desirable to provide an improved process for providing a pet owner with memorabilia including a casting of a pet's paw.

Therefore, it is a principal object of the instant invention to provide an improved method and apparatus for producing memorabilia.

A further object of the invention is to provide an improved method and apparatus for providing memorabilia including a casting of a pet's paw.

These and other, further and more specific objects and advantages of the invention will be apparent from the following detailed description of the invention, taken in conjunction with the drawings, in which:

FIG. 1 is a perspective view illustrating the use of impression material to obtain an impression of a pet's paw;

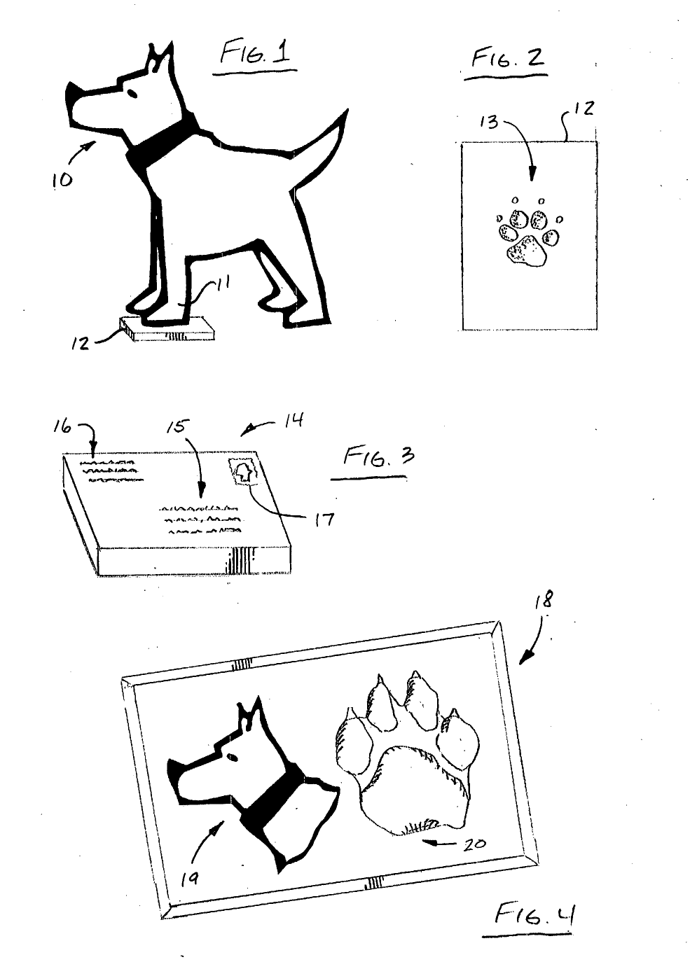

FIG. 2 is a top view of the impression produced in the impression material;

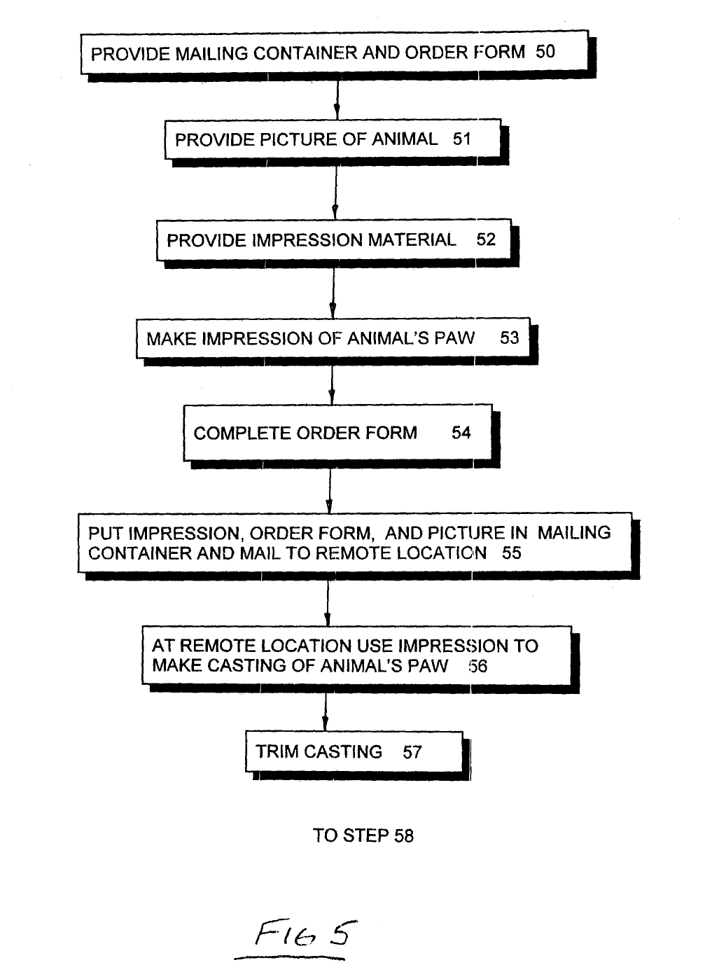

FIG. 3 is a perspective view of a container for the impression and accompanying order form;

FIG. 4 is a perspective view illustrating a display including a casting of a pet's paw;

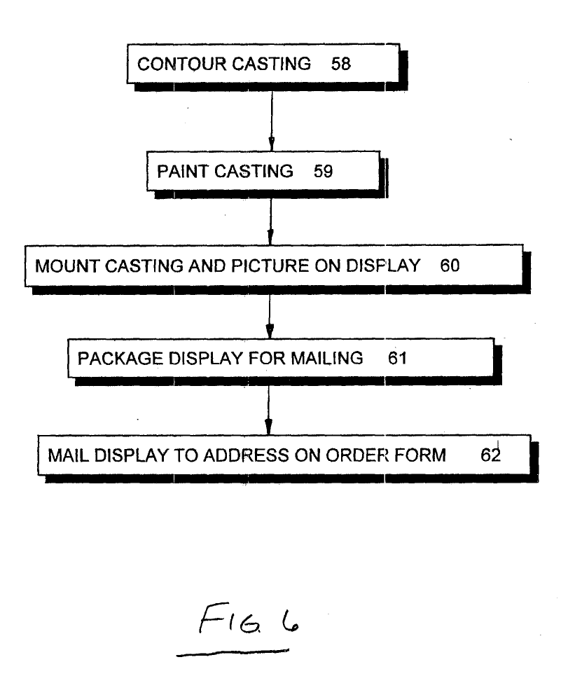

FIG. 5 is a block flow diagram illustrating a method for producing pet memorabilia in accordance with the invention; and,

FIG. 6 is a block flow diagram further illustrating a method for producing pet memorabilia in accordance with the invention.

Briefly, in accordance with my invention, I provide an improved method for producing pet memorabilia. The method includes the steps of providing impression material; providing a mailing container; making in the impression material an impression of a pet's paw; placing the impression material in the mailing container; mailing the mailing container to a remote location; at the remote location, removing the impression material from the mailing container on receipt of the same; preparing a casting material; administering the casting material to the impression in the impression material to form a casting replicating the pet's paw; finishing the casting; mounting the casting on a display; packaging the display to be mailed; and, mailing the packaged display.

In another embodiment of the invention, I provide an improved method for producing pet memorabilia. The improved method comprises the steps of providing an impression of a pet's paw; preparing a casting material by admixing cellulose fibers to clay in a ratio of cellulose fibers to clay by weight in the range of 1:7.5 to 2:1; applying the casting material to the impression to form a casting of the pet's paw; removing the casting from the impression; sculpting the casting; drying the casting; painting the dried casting; and, sealing the casting.

In a further embodiment of the invention, we provide improved pet memorabilia. The memorabilia comprises a display; a pet's picture mounted on the display; and, a casting of a paw of the pet mounted on the display.

In still another embodiment of the invention, we provide an improved pet memorabilia kit. The kit includes impression material; a mailing container for the impression material; a form for ordering a casting of the impression of a pet's paw made in the impression material.

In still a further embodiment of the invention, I provide improved pet memorabilia. The memorabilia comprises a display; a leash mounted on the display; and, a casting of a paw of the pet mounted on the display.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a pet 10 with his paw 11 pressed on impression material 12.

FIG. 2 illustrates the impression 13 made in impression material 12 by the pet's paw 11.

FIG. 3 illustrates a mailing container 14. Container 14 includes mailing address 15, return address 16, and postage 17. The postage can be provided on the container when purchased by a pet owner, or the pet own can affix the postage prior to mailing container 14. Mailing address 15 is the address of a processing center remote from the residence of a pet owner or from the location from which container 14 is mailed. Return address 16 typically indicates the address from which container 14 is mailed. Container 14 is shaped and dimensioned such that impression material 12 and the ordering instruction sheet or sheets (not visible) can be inserted inside container 14 and container 14 can be closed, and if desired, sealed.

FIG. 4 illustrates a display 18 comprised of a board or other backing. Any desired material can be utilized to fabricate display 18 in any desired shape, dimension, and color or colors. A photograph or other picture 19 of pet 10 is mounted on display 18 along with a casting 20 of the paw of the pet. The photograph can be mounted by the remote processing center that prepares casting 20, or, can be mounted on display 18 by the pet owner once the pet owner receives the display from the remote processing center. The name of the pet and other information, pictures, artwork, etc. can also be mounted on or formed in or on display 18. For example, the pet's name or other information can be engraved on a plate attached to display 18.

The method and apparatus utilized to produce the pet memorabilia illustrated in FIG. 4 is explained in more detail with reference to FIGS. 5 and 6.

A pet owner purchases or is otherwise provided with a mailing container and order form 50. The shape, dimension, and composition of the mailing container 14 can vary as desired. However, container 14 preferably is sized to receive and transport impression material 12 and an order form, and, possible a photograph of an animal. The order form can include the name and address of the pet owner (or other person making the order) and the address to which the completed memorabilia 18, 19, 20 is mailed. The order form also typically includes additional information used to prepare the memorabilia. Such additional information can include, by way of example and not limitation, whether the display 18 is made from oak, walnut, or cherry wood; the information to be engraved on a plate to be mounted on display 18; whether the display will include a picture 19 of the pet; whether a leash will be mounted (permanently or removably) on the display 18; whether display 18 will be solid wood or veneer; whether portions of the casting (for example, the pet's nails) will be enhanced; a table for calculating the cost of having the memorabilia prepared, including shipping and handling and tax; information for paying for the order with a credit card; and, a space for the pet owner (or other customer) to sign and date the order form.

In step 51, a photograph or other picture or depiction of the pet or other animal is provided. As noted, the pet owner may elect not to send a photograph to the remote processing center and may elect to attach a photograph to display 18 once the pet owner receives display 18 from the remote processing center. Also, a leash may be mounted on display 18, with or without a photograph.

In step 52, impression material 12 is provided. The impression material typically comprises a soft molding clay. Such molding clays are widely available. It is presently preferred, although not required, that container 14, impression material 12, and the order form be provided together as a kit, with material 12 and the order form packaged inside container 14 and with the address 15 of the remote processing center pre-printed on container 14 This enables the pet owner to use container 14 to mail to the remote processing center the impression material 12 (with an impression of the pet's paw formed therein) and the order form. Instructions for taking a paw print with material 12 can also be included in the kit along with material 12 and the order form. By way of example, and not limitation, the instructions for taking a paw print can read:

[image]

[image]

In step 54, the order form is completed. On the order form, the customer typically writes his name and address; writes the address to which the completed memorabilia is to be mailed; calculates the amount owed for the order; provides the necessary information if paying by credit card; selects whether display 18 is made from veneer or wood and, if wood, the kind of wood; provides information to be engraved on a plate attached to display 18; indicates the pet's name to be placed on a name plate to be attached to display 18; indicates whether a photograph of the pet or a leash will be included on display 18; and, provides other desired information. When a photograph is to be included on the display 18, the remote processing center can mount a photo sleeve or holder on display 18. When a leash is to be included on the display 18, the remote processing center can mount a hook or other leash holder on display 18.

In step 55, the impression material 12 (with the pet's paw impression formed therein), the order form, and, if appropriate, a picture of the pet and a check or money order to pay for the order and placed in container 14. Container 14 is closed, and if desired sealed, and is placed in the mail to be delivered to the remote location indicated by address 15. The U.S. Postal Service, Fed Ex, UPS, or any other desired mail service can be utilized.

In step 56, the processing center removes the impression material 12 from container 14 on receipt thereof. The impression formed in material 12 is used to make a casting. A wide variety of casting materials are available. An important objective of the invention, however, is to use a casting material and process that minimizes the time and expense in producing the casting and that minimizes the likelihood that the resulting casting can be damaged or can pose a health risk to a pet owner, pet, or other individuals. Consequently, in the practice of the invention, a wide variety of materials are not desirable. For example, molding clay is breakable when dried and does not readily pick up detail from the paw impression. Gypsum cement is breakable, is toxic, and is difficult to file when dried. Liquid acrylic resins are toxic and when dry are difficult to file. The casting material preferred in the invention is utilized using cellulose fibers or cellulose powder admixed to clay. The cellulose fibers or powder are added to clay in a proportion of cellulose to clay by weight in the range of 1:7.5 to 2:1; When cellulose fibers are utilized, the length of the fibers can vary as desired but typically are in the range of 1/128 inch to 1/4 inch. The fibers add strength to the clay. Any desired clay can be utilized in combination with the fibers. When cellulose powder is utilized the size of the powder particles can vary as desired but typically is in the range of 50 mesh to 300 mesh. A partitioning agent like talc, silica, ash, etc. can be included in the cellulose—clay mixture to reduce the likelihood that the mixture will stick to the impression and to facilitate kneading the material. The partitioning agent can comprise from 0.1% to 40% by weight of the cellulose—clay casting composition. The casting composition can also include minor effective amounts of one ore more preservatives. Other hydrophilic materials like starch, carageenan, etc. can be included with the cellulose in concentrations by weight in the final composition of 0.1% to 20%. The clay particles typically, but not necessarily, have a width or diameter equal to or less than 0.000157 inch (4 microns). The particulate comprising clay can vary as desired. Tiny clay particles can comprise silicate minerals or can comprise tiny, sheet-like particles of alumina and silica or other minerals or other materials. The cellulose-clay composition has several advantages. First, it is relatively inexpensive. Second, the composition picks up fine detail in an impression. Third, the composition dries at an ambient temperature of seventy-six degrees F. in about one day. Fourth, after the composition is pressed into an impression, it is readily removed without sticking to the impression. Fifth, after the composition is pressed into an impression and is removed, the composition is readily sculpted by (1) removing excess pieces of the composition, which is easily accomplished with a knife or other instrument, (2) manually applying hot water and using fingers to smooth the edges or other areas of the casting. Sixth, after the casting dries, it is readily further sculpted by using a woman's nail emery board or sand paper with a fine grit. Seventh, once the composition has dried it is not brittle and is difficult to break. Eighth, the composition is non-toxic. Ninth, a composition comprised of cellulose fibers or powder and clay is relatively inexpensive. Tenth, since the composition is readily sculpted when “wet” or dry, the time required to smooth, shape, and otherwise finish a casting made with the composition is minimal, typically about five minutes or less. This minimal labor requirement significantly reduces production costs.

In step 56, the cellulose-clay composition is pressed into the impression to form a casting of the animal's paw.

In step 57, the casting is removed from the impression and is trimmed, typically with a knife, scalpel, or other sharp instrument.

In step 58, the casting is further sculpted by manually applying hot water to smooth selected areas of the casting and/or by removing portions of the casting as would a sculptor to shape and define the contour and dimension of the casting.

In step 59, after the casting is allowed to dry, the casting is painted. The preferred painting procedure is to apply two coats of metallic water base copper paint. About five minutes after the first coat is applied at ambient temperature, the second coat is applied. The second coat is allowed to dry in the ambient air typically for a minimum of four hours, depending on atmospheric temperature and conditions. Sculptor's black wax is then applied with a paint brush. Black wax can be obtained from a variety of sources, but once source is Sculpt Nouveau of P.O. Box 460459, Escondido, Calif. 92046, www.sculptnouveau.com, 800 728 5787. The wax has the consistency of beeswax. The casting is substantially covered with the wax and is buffed with a soft towel to remove some of the wax and give the casting an antique appearance. The wax, in addition to producing an aesthetically pleasing appearance, functions to seal the paint and casting. Other sealers can, if desired, be utilized. Another reason the black wax is preferred is that patina gives inconsistent results and is not preferred. The wax is permitted to dry for about fifteen minutes to one hour and is then buffed with a polishing wheel. A soft lambs-wool like material on the wheel functions to buff the wax. Black wax typically includes additives like binders, UV-rust inhibitors, and hardeners. Once the wax is buffed, production of the casting is completed.

In step 60 the casting 20 is glued or otherwise fastened to a display to complete production of the memorabilia. One possible display 18 is illustrated in FIG. 4. A photograph or other picture 19 of the animal for which the casting 20 is made can also, if desired, be mounted on display 18. A plate or plates bearing the animal's name or other information can be mounted on the front or back of display 18. Any desired method or equipment can be utilized to mount information on display 18, or engrave, paint, carve or otherwise form alphanumeric characters, pictures, or other symbols on or in display 18.

In step 61 the completed memorabilia is packaged to be mailed. The package includes the return address that was set forth on the order form.

In step 62 the package is mailed to the return address.

Using the combined efforts of the pet owner and of a remote processing center in accordance with the invention makes the production for the pet owner of a casting and other pet memorabilia a practical, inexpensive exercise.

Having described my invention in such terms as to enable those of skill in the art to make and practice it, and having described the presently preferred embodiments thereof, I claim:

1. A method for producing pet memorabilia, comprising the steps of
(a) providing impression material;
(b) providing a mailing container;
(c) making in said impression material an impression of a pet's paw;
(d) placing said impression material in said mailing container;
(e) mailing said mailing container to a remote location;
(f) at the remote location, removing said impression material from said mailing container on receipt of the same;
(g) preparing a casting material;
(h) administering said casting material to said impression in said impression material to form a casting replicating said pet's paw;
(i) finishing said casting;
(j) mounting said casting on a display;
(k) packaging said display to be mailed; and,
(l) mailing said packaged display.

2. A method for producing pet memorabilia, comprising the steps of
(a) providing an impression of a pet's paw;
(b) preparing a casting material by admixing cellulose fibers to clay in a ratio of cellulose fibers to clay by weight in the range of 1:7.5 to 2:1;
(c) applying said casting material to said impression to form a casting of said pet's paw;
(d) removing said casting from said impression;
(e) sculpting said casting;
(f) drying said casting;
(g) painting said dried casting; and,
(h) sealing said casting.

3. Pet memorabilia comprising
(a) a display;
(b) a pet memorabilia mounted on said display; and,
(c) a casting of a paw of the pet mounted on said display.

4. A pet memorabilia kit comprising
(a) impression material;
(b) a mailing container for said impression material;
(c) a form for ordering a casting of the impression of a pet's paw made in said impression material.
